(19) United States
(12) Patent Application Publication
(10) Pub. No.: US 2004/0189287 A1
(43) Pub. Date: Sep. 30, 2004

(54) Position detecting sensor

(75) Inventors: Takashi Suzuki, Ohbu-shi (JP); Keiji Yasuda, Handa-shi (JP); Takayoshi Tsuzuki, Toyota-shi (JP); Hirofumi Endoh, Toyota-shi (JP); Satoru Tagawa, Takahama-shi (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA

(21) Appl. No.: 10/722,405

(22) Filed: Nov. 28, 2003

(30) Foreign Application Priority Data
Nov. 28, 2002 (JP) 2002-346024

(51) Int. Cl. G01B 7/14

(52) U.S. Cl. 324/207.24

(57) ABSTRACT

A position detecting sensor includes a first magnet having a first pole and a second pole, and a second magnet having a first pole and a second pole. The first pole of the second magnet faces the second pole of the first magnet. The position detecting sensor further includes a magnetic detecting element in the vicinity of the first and second magnets. A magnetic flux density detected in a zone including the magnetic detecting element while a detected body is away from the position detecting sensor more than a predetermined distance is greater than a magnetic flux density detected in the zone while the detected body is positioned near at least one side of the position detecting sensor by the predetermined distance.

### CROSS REFERENCE TO RELATED APPLICATIONS

This application is based on and claims priority under 35 U.S.C. §119 with respect to Japanese Patent Application 2002-346024, filed on Nov. 28, 2002, the entire contents of which are incorporated herein by reference.

### FIELD OF THE INVENTION

This invention generally relates to a position detecting sensor configured to detect a position of a magnetic body. More particularly, this invention pertains to a seat position detecting sensor configured to detect a seat-position, for example of a vehicle.

### BACKGROUND OF THE INVENTION

A position detecting sensor is mounted to a seat sliding device for adjustable control of a position of a vehicle seat in a longitudinal direction and is applied for detecting a positional relationship of the vehicle seat with-a vehicle floor. This type of position detecting sensor has been disclosed in U.S. patent publication No. 6,053,529. The position detecting sensor is mounted to the seat sliding device and is provided with a sensor flange fixed to one of an upper rail and a lower rail. The upper and lower rails are mounted in a slidable relationship therewith. The position detecting sensor is further provided with a magnetic sensor fixed to the other of the upper and lower rails. The magnetic sensor is mounted in an upward fashion so as to receive both sides of the sensor flange therethrough. The magnetic sensor includes a magnetic detecting element, a magnetic circuit, and at least a magnet. The sensor flange is designed to have a predetermined length along a slidably moving direction of the seat rail. As described above, the position detecting sensor detects the seat position in the slidably moving direction by distinguishing a zone, in which the sensor flange interrupts magnetic force of the magnet from reaching the magnetic detecting element, from the other zone, in which the sensor flange does not interrupt the magnetic force from reaching the magnetic detecting element.

However, according to the above-described position detecting sensor, the both sides of the sensor flange is received by the magnetic sensor, thereby unnecessarily increasing a lateral dimension of the magnetic sensor. In this case, it may be difficult to mount the magnetic sensor to a sideward portion of the seat rail that is generally narrowly spaced. Further, a seat frame portion and the seat sliding device are made of steal plates, respectively. Each dimension or structure of the seat frame portion and the seat sliding device may vary depending on a vehicle type. In this case, magnetic conditions around or of the magnetic detecting element may fluctuate depending on the vehicle type. Therefore, even when the magnetic sensor for each vehicle type is provided with identical magnetic detecting element and magnetic field, output from each magnetic sensor may be differently characterized. What is more, there may be a case that each magnetic sensor can not be provided with the identical magnetic element and magnetic field. Up to the present, a magnetic sensor has been provided with a magnetic detecting element and a magnetic field in accordance with magnetic conditions for each vehicle type. This approach achieved success to offset fluctuation of the magnetic conditions. In the meantime, this approach may still leave a concern about manufacturing cost increase.

In light of foregoing, a need thus exists for providing an improved position detecting sensor which enables to decrease the lateral dimension of the magnetic sensor, can be provided with identical magnetic detecting element and magnetic field for each vehicle type, and can easily adjust output from the position detecting sensor.

### SUMMARY OF THE INVENTION

According to an aspect of the present invention, a position detecting sensor includes a first magnet having a first pole and a second pole, and a second magnet having a first pole and a second pole and positioned near the first magnet. The first pole of the second magnet faces the second pole of the first magnet. The first pole of the first magnet is the same as the first pole of the second magnet. The second pole of the first magnet is the same as the second pole of the second magnet. The position detecting sensor further includes a magnetic detecting element in the vicinity of the first and second magnets. A magnetic flux density detected in a zone including the magnetic detecting element while a detected body is away from the position detecting sensor more than a predetermined distance is greater than a magnetic flux density detected in the zone while the detected body is positioned near at least one side of the position detecting sensor by the predetermined distance.

It is preferable that the position detecting sensor further includes a first yoke positioned between the first magnet and the second magnet, a projecting portion extending at the first yoke in a direction at approximately right angles with a line extending between the first and second magnets, a second yoke positioned so as to dispose the magnetic detecting element between the second yoke and a tip end of the projecting portion, and a third yoke oriented near the projecting portion at the second pole side of the second magnet and at one side of the second yoke. The magnetic detecting element is positioned in the vicinity including a line extending between the tip end of the projecting portion and the second yoke, wherein the detected body approaches to the first pole side of the first magnet and the other side of the second yoke. In this case, the magnetic flux density can widely vary between a detecting zone and a non-detecting zone.

### BRIEF DESCRIPTION OF THE DRAWING FIGURES

The foregoing and additional features and characteristics of the present invention will become more apparent from the following detailed description considered with reference to the accompanying drawing figures, wherein:

FIG. 1 is a cross sectional view illustrating a position detecting sensor according to a first embodiment of the present invention;

FIG. 2 is a side view illustrating the position detecting sensor according to the first embodiment of the present invention;

FIG. 3 is an explanatory view for explaining magnetic flux circuit when the position detecting sensor does not detect a detected body according to the first embodiment;

FIG. 4 is an explanatory view for explaining the magnetic flux circuit when the position detecting sensor detects the detected body according to the first embodiment;

FIG. 5 is a diagram for explaining characteristics of the position detecting sensor for detecting magnetic flux density according to embodiments of the present invention;

FIG. 6 is a diagram for explaining characteristics of the position detecting sensor for outputting electric current according to the embodiments of the present invention;

FIG. 7 is an explanatory view for explaining magnetic flux circuit when the position detecting sensor does not detect the detected body according to the second embodiment;

FIG. 8 is an explanatory view for explaining magnetic flux circuit when the position detecting sensor does not detect the detected body according to the third embodiment;

FIG. 9 is an explanatory view for explaining magnetic flux circuit when the position detecting sensor does not detect the detected body according to the fourth embodiment; and

FIG. 10 is an explanatory view for explaining magnetic flux circuit when the position detecting sensor does not detect the detected body according to the fifth embodiment.

### DETAILED DESCRIPTION OF THE INVENTION

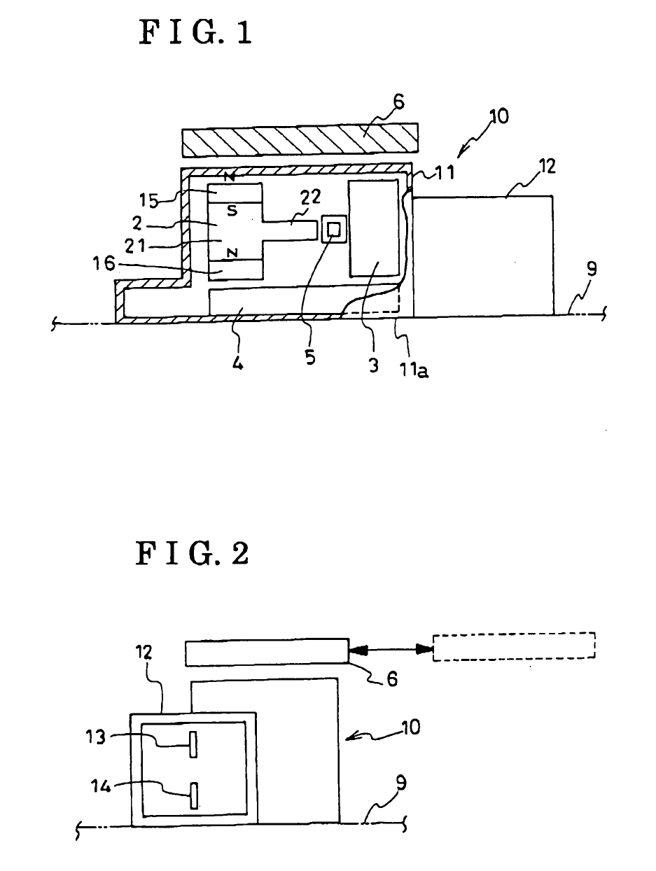

FIGS. 1 through 6 illustrate a position detecting sensor 10 according to a first embodiment of the present invention. As illustrated in FIGS. 1 and 2, the position detecting sensor 10 is provided with a case 11 and a connector portion 12 at the case 11. The connector portion 12 includes terminals 13 and 14 such that the connector portion 12 is configured to transmit a signal outputted from the position detecting sensor 10 to an electronic control circuit (not shown) via a wiring harness (not shown). The case 11 houses a magnet 15 and a magnet 16, each of which is a dipole magnet having two poles usually designated with “north” and “south” by analogy with the Earth's dipole magnetic field. The magnet 15 is oriented to face south end thereof at north end of the magnet 16. Positioned is a main body portion 21 of a first yoke 2 between the magnets 15 and 16. The first yoke 2 further includes a projecting portion 22 which extends from the vicinity of an approximately central portion of a line between the magnets 15 and 16 and in a direction at approximately right angles with the line.

The case 11 can further houses a second yoke 3 positioned with a predetermined space from a tip end of the projecting portion 22. The length of the second yoke 3 in the up-and-down direction is designed to be substantially the same as a dimension between the magnets 15 and 16 positioning the first yoke 2 therebetween. The case 11 still can further house a third yoke 4 extending substantially in parallel with the projecting direction of the projecting portion 22. The third yoke 4 can be arranged to have a predetermined space relative to one end of the second yoke 3 and one of the magnets 15 and 16. The first yoke 2, the second yoke 3, and the third yoke 4 are made of magnetic material, respectively.

A magnetic detecting element 5 is positioned between the tip end of the projecting portion 22 and the second yoke 3. The magnetic detecting element 5 is configured to detect magnetic flux density and can be represented by a Hall IC as a non-limiting example. The magnetic detecting element 5 is oriented for detecting the magnetic flux density in the extending direction of the projecting portion 22.

As illustrated in FIG. 1, the position detecting sensor 10 according to the first embodiment of the present invention is attached to a stationary portion 9 by means of screws (not shown) via an attached surface 1 la which corresponds to an outer surface of the case 11 near the third yoke 4. The position detecting sensor 10 detects a position of a movable magnetic body 6 as a detected member which is positioned at the opposite side of the attached surface 11a outside the case 11. Turning now to FIG. 2, when the magnetic body 6 is positioned away from the position detecting sensor 10, for example as illustrated with a dotted line, the position detecting sensor 11 outputs Hi electric current as being explained in FIG. 6. In the meantime, when the magnetic body 6 is positioned near the position detecting sensor 10, for example as illustrated with a solid line in FIG. 2, the position detecting sensor 10 outputs Lo electric current as being explained in FIG. 6. The position of the magnetic body 6 can be hence detected in the above-described manner. Herein, the position detecting sensor can output the Lo electric current when the magnetic body 6 is positioned away from the position detecting sensor 10, and can output the Hi electric current when the magnetic body 6 is positioned near there.

When the position detecting sensor 10 is applied for detecting a seat position for example, a bracket (corresponding to the magnetic body 6) extends with a predetermined longitudinal length along a slidably moving direction of a seat rail, wherein the position detecting sensor 10 and the bracket can be configured for their relative movement. Therefore, the position detecting sensor 10 can distinguish whether the bracket is positioned near to the sensor 10 or away therefrom. The magnetic body 6 can be integrally formed at a portion of the seat rail.

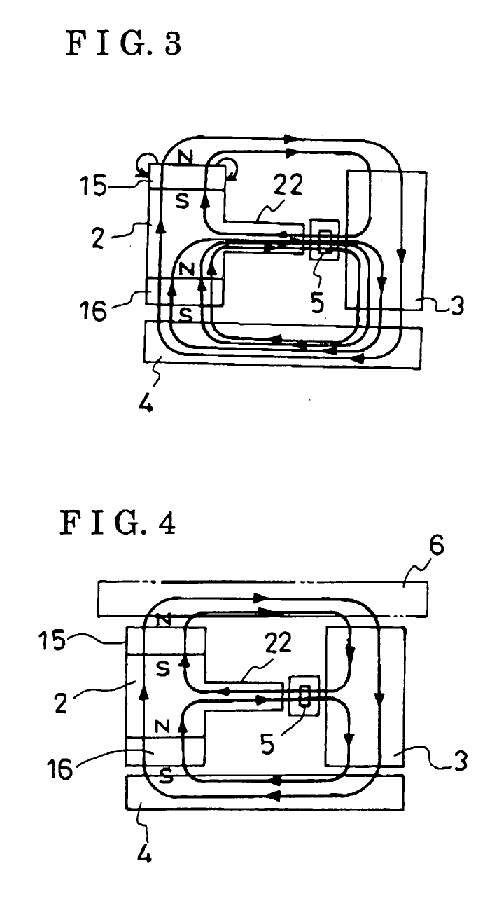

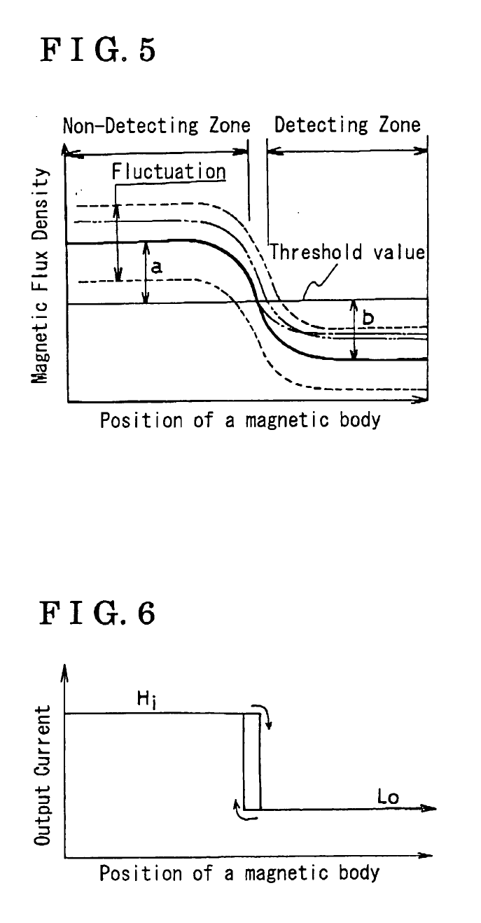

Next, following description will be given for explaining operation of the position detecting sensor 10 with the above-described structure. As illustrated with lines of magnetic flux in FIG. 3, when the magnetic body 6 is positioned away from the position detecting sensor 10, magnetic flux from the magnet 15 travels from north end thereof heading towards the second yoke 3 via a space which is above the position detecting sensor 10 in the drawing. The magnetic flux then flows back to south end of the dipole magnet 15 via the magnetic detecting element 5 and the projecting portion 22. Meanwhile, magnetic flux from the magnet 16 travels from north end thereof heading towards the second yoke 3 via the projecting portion 22 and the magnetic detecting element 5. The magnetic flux then flows back to south end of the dipole magnet 16 via the third yoke 4. The lines of magnetic flux are imaginary lines used to illustrate and describe the pattern and force of the magnetic flux existing in the surrounding area. The lines of magnetic flux from the magnet 15 flows in an opposite direction to the lines of magnetic flux from the magnet 16 in a zone including the magnetic detecting element 5 and the projecting portion 22. Therefore, the magnetic flux from each magnet 15 and 16 may act to cancel each other in the zone. The magnetic force emanating from the magnet 15 travels through the surrounding space between the magnet 15 and the second yoke 3. Meanwhile, the magnetic force emanating from the magnet 16 travels through the third yoke 4 between second yoke 3 and the magnet 16. The third yoke 4 is a magnetic body which can attract slightly larger magnetic force than the surrounding space between the magnet 15 and the second yoke 3. Therefore, comparing with the magnetic force from the magnet 15 with the magnetic force from the magnet 16, the density of the magnetic flux emanating from the magnet 16 is slightly larger than the density of the magnetic flux emanating from the magnet 15 in the zone including the magnetic detecting element 5 and the projecting portion 22, wherein the magnetic flux from the magnet 16 is not cancelled. The larger density of the magnetic flux is illustrated and described with the lines of magnetic flux extending in the right direction in FIG. 3. As a result, the magnetic flux from the magnet 16 can be detected by the magnetic detecting element 5. The detected magnetic flux in the zone including the magnetic detecting element 5 becomes substantially equal lo or greater than a predetermined threshold value as illustrated in FIG. 5. The position detecting sensor 10 then outputs the Hi electric current as illustrated in FIG. 6.

On the other hand, turning now to FIG. 4, when the magnetic body 6 is positioned near or adjacent to the position detecting sensor 10, the magnetic flux emanating from north end on the magnet 15 passes through the magnetic body 6 heading towards the second yoke 3. In this case, the magnetic force from the magnet 15 passing through the zone including the magnetic detecting element 5 is approximated to the magnetic flux emanating from north end on the magnet 16, wherein each magnetic flux in the zone is canceled and diminished. Magnetic permeability of the third yoke 4 can be considered to be substantially equal to magnetic permeability of the magnetic body 6. As explained in FIG. 5, the density of the magnetic flux in the zone including the magnetic detecting element S becomes substantially equal to or less than the predetermined threshold value. The position detecting sensor 10 then outputs the Lo electric current as illustrated in FIG. 6. According to the first embodiment of the present invention, the Hi electric current is designed to be greater than the Lo electric current.

As explained in FIG. 5, the detecting characteristics of the position detecting sensor 10 according to the first embodiment of the present invention may be largely influenced by magnetic properties of peripheral devices or circumstances of the position detecting sensor 10. For example, the prescribed detecting characteristics of the position detecting sensor 10 is set as illustrated with a solid line in FIG. 5. When the other magnetic body is positioned at the attached surface 11a of the position detecting sensor 10 so as to improve magnetic flux attracting characteristics of the third yoke 4, the position detecting sensor 10 may detect higher magnetic flux density in the zone including the magnetic detecting element 5. In this case, the detecting characteristics of the position detecting sensor 10 is described with a chain double-dashed line which is shifted above the solid line in FIG. 5. On the other hand, when the other magnetic body is positioned near the magnetic body 6, the position detecting sensor 10 may detect lower magnetic flux density in the zone including the magnetic detecting element 5. In this case, the detecting characteristics of the position detecting sensor 10 is described with a dashed line which is shifted below the solid line in FIG. 5. Further, even when the magnetic body 6 is close to the position detecting sensor 10 and yet is away therefrom compared with a predetermined close position, the detecting characteristics of the position detecting sensor 10 is described with a dashed line which is shifted above the solid line in a detecting zone in FIG. 5.

As described above, the magnetic conditions around or of the position detecting sensor 10 may vary depending on each product, for example depending of each vehicle type which has a different seat mounted thereon. This may undesirably lead fluctuation of the detecting characteristics of the position detecting sensor 10, wherein the magnetic flux density may not be able to be detected based upon the predetermined threshold value. In order to overcome the problem, the threshold value can be respectively designed in accordance with magnetic conditions of each product. However, this requires designing a highly cost magnetic detecting element and a control circuit in accordance with each product, which may cause manufacturing cost increase.

In light of foregoing, according to the first embodiment of the present invention, detection margins a and b are appropriately set relative to the threshold value in each non-detecting zone and detecting zone as illustrated in FIG. 5. Accordingly, the position detecting sensor 10 applied for the same vehicle type can surely distinguish the non-detecting zone from the detecting zone even when the detected magnetic flux deviates from the magnetic flux illustrated with the solid line in FIG. 5. Therefore each vehicle type can be provided with the position detecting sensor 10 having the identical magnetic detecting element 5 and control circuit, thereby leading the manufacturing cost reduction.

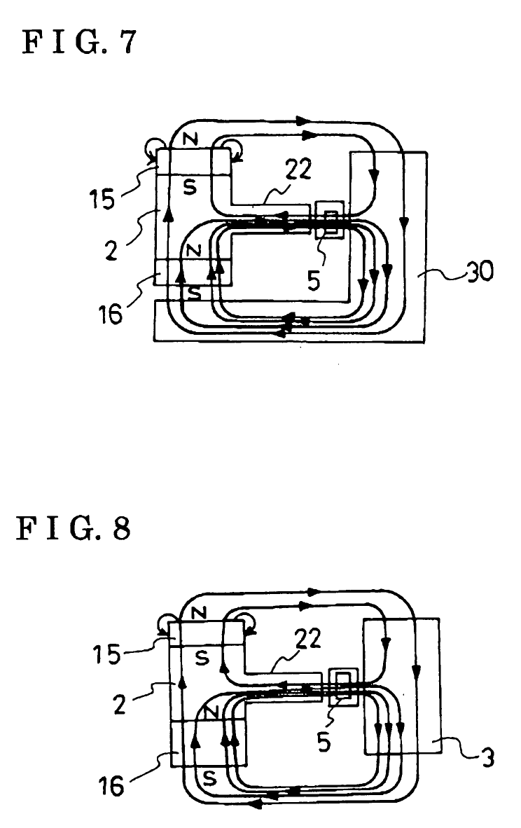

Turning now to FIG. 7, according to a second embodiment of the present invention, the position detecting sensor 10 can be provided with a yoke 30. The yoke 30 has an integral shape of the second yoke 3 and the third yoke 4 of the first embodiment. In this case, the detecting characteristics of the position detecting sensor 10 can be restrained from fluctuating due to the magnetic conditions in the vicinity including the position detecting sensor 10. Further, the detecting characteristics thereof can be effectively stabilized. The other structure of the position detecting sensor 10 according to the second embodiment of the present invention is substantially identical to the structure thereof according to the first embodiment.

According to the first or second embodiment of the present invention, when the position detecting sensor 10 is applied for a seat rail, an attaching portion of the seat rail can be along or on the third yoke 4 or the yoke 30. In this case, fewer components can be used for the position detecting sensor 10 or a seat sliding device, thereby leading manufacturing cost reduction. Further, even when a magnetic foreign substance adjacent to or on the seat rail is attached to or near the position detecting sensor 10, the detecting characteristics of the position detecting sensor 10 is not influenced much and can be effectively stabilized.

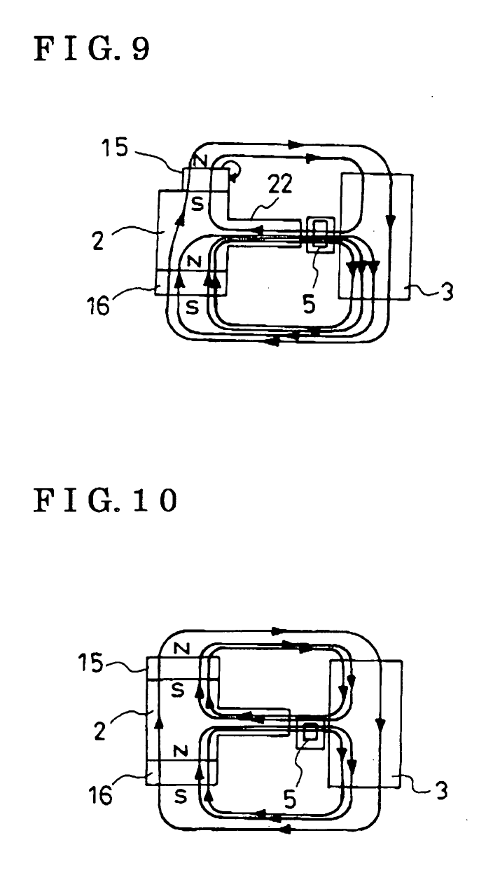

Further, for the purpose of designing the margins a and b properly and inexpensively, according to a third embodiment of the present invention illustrated in FIG. 8, the thickness of each magnet 15 and 16 differs in a direction of the line extending therebetween. In the same manner, according to a fourth embodiment of the present invention illustrated in FIG. 9, the thickness of each magnet 15 and 16 differs in a direction at right angles with the line extending therebetween. In this case, the magnetic flux density in the zone including the magnetic detecting element S can be adjusted. Therefore, the position detecting sensor 10 can be downsized, and the detecting characteristics of the position detecting sensor 10 can be controlled without increasing the number of components.

Still further, according to a fifth embodiment of the present invention illustrated in FIG. 10, the position of the magnetic detecting element 5 can be shifted in a down direction in the drawing—i.e., in a direction at right angles with the lines of magnetic flux extending in the zone including the magnetic detecting element 5. Therefore, the magnetic flux density in the zone can be relatively easily adjusted.

It is certain that the position detecting sensor 10 can have a structure in combination with any of the structures of the above five embodiments. The position detecting sensor 10 of the present invention is not limited to the above described embodiments.

As described above, the position detecting sensor 10 can detect the magnetic body 6 when approaching to one side of the sensor 10. Therefore, the position detecting sensor 10 can be mounted even in a narrow space. The magnetic flux detecting characteristics of the position detecting sensor 10 can be effectively adjusted such that the position detecting sensor 10 for each product can be provided with the identical magnetic detecting element and the control circuit Therefore, the position detecting sensor 10 can be manufactured inexpensively.

The principles, preferred embodiments and mode of operation of the present invention have been described in the foregoing specification and drawings. However, the invention which is intended to be protected is not to be construed as limited to the particular embodiment disclosed. Further, the embodiments described herein are to be regarded as illustrative rather than restrictive. Plural objectives are achieved by the present invention, and yet there is usefulness in the present invention as far as one of the objectives are achieved. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A position detecting sensor comprising:
a first magnet having a first pole and a second pole;
a second magnet having a first pole and, a second pole and positioned near the first magnet, the first pole of the second magnet facing the second pole of the first magnet, the first pole of the first magnet being the same as the first pole of the second magnets and the second pole of the first magnet being the same as the second pole of the second magnet; and
a magnetic detecting element in the vicinity of the first and second magnets, wherein a magnetic flux density detected in a zone including the magnetic detecting element while a detected body is away from the position detecting sensor more than a predetermined distance is greater than a magnetic flux density detected in the zone while the detected body is positioned near at least one side of the position detecting sensor by the predetermined distance.

2. A position detecting sensor according to claim 1, further comprising:
a third yoke positioned at the second pole side of the second magnet, wherein the detected body approaches to the first pole side of the first magnet.

3. A position detecting sensor according to claim 2, wherein the third yoke is separated from the second pole of the second magnet by a predetermined distance.

4. A position detecting sensor according to claim 1, further comprising:
a first yoke positioned between the first magnet and the second magnet;
a projecting portion extending at the first yoke in a direction at approximately right angles with a line extending between the first and second magnets;
a second yoke positioned so as to dispose the magnetic detecting element between the second yoke and a tip end of the projecting portion; and
a third yoke oriented near the projecting portion at the second pole side of the second magnet and at one side of the second yoke,
wherein the magnetic detecting element is positioned in the vicinity including a line extending between the tip end of the projecting portion and the second yoke, and wherein the detected body approaches to the first pole side of the first magnet and the other side of the second yoke.

5. A position detecting sensor according to claim 4, wherein the third yoke is separated from the second pole of the second magnet and from the one side of the second yoke by a predetermined distance.

6. A position detecting sensor according to claim 4, wherein the third yoke is provided integrally with the second yoke.

7. A position detecting sensor according to claim 3, wherein a thickness of the first magnet differs from a thickness of the second magnet, and the thickness of each magnet is a dimension in parallel with the direction extending between the first and second magnets.

8. A position detecting sensor according to claim 4, wherein a thickness of the first magnet differs from a thickness of the second magnet, and the thickness of each magnet is a dimension in parallel with the direction extending between the first and second magnets.

9. A position detecting sensor according to claim 3, wherein a thickness of the first magnet differs from a thickness of the second magnet, and the thickness of each magnet is a dimension at substantially right angles with the direction extending between the first and second magnets.

10. A position detecting sensor according to claim 4, wherein a thickness of the first magnet differs from a thickness of the second magnet, and the thickness of each magnet is a dimension at substantially right angles with the direction extending between the first and second magnets.

11. A position detecting sensor according to claim 3, wherein the magnetic detecting element is shifted towards the third yoke.

12. A position detecting sensor according to claim 4, wherein the magnetic detecting element is shifted in a direction at right angles with the extending direction of the projecting portion.

13. A position detecting sensor according to claim 4, wherein the projecting portion extends from an approximately central portion of the first yoke.

14. A position detecting sensor according to claim 4, wherein the third yoke is positioned in parallel with the extending direction of the projecting portion.

15. A position detecting sensor according to claim 3, wherein the third yoke has substantially the same feature as the detected body with respect to magnetic permeability.
